(19) United States
(12) Patent Application Publication
(10) Pub. No.: US 2007/0052615 A1
(43) Pub. Date: Mar. 8, 2007

(54) Configurable auxiliary output device for information

(75) Inventors: Niels Van Dongen, Seattle, WA (US); Andrew J. Fuller, Redmond, WA (US); Seiya Ohta, Issaquah, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/474,686

(22) Filed: Jun. 26, 2006

Related U.S. Application Data
(60) Provisional application No. 60/715,246, filed on Sep. 8, 2005.

(51) Int. Cl. G09G 5/00

(52) U.S. Cl. 345/1.1

(57) ABSTRACT

Described is the outputting of a representation of complex state or other information to an output mechanism, such as computer program state data, in which the output of the state information is configurable. The state information is conveyable via the output mechanism, which may be an auxiliary display device, such as at least one LED and/or luminescent strip, and which may be viewed from a large distance relative to text and graphics displays, and/or remotely on a peripheral device. Logic receives state data from a data source such as an application program, and applies configuration data such as rules and/or user defined preferences to selectively control the output to be conveyed. Various state data may be conveyed via differing colors, differing numbers of LEDs illuminated, differing brightness, differing color intensity, differing hue and/or differing flash/pulse patterns. State information that is output is updatable when some state change occurs.

### CROSS REFERENCE TO RELATED APPLICATIONS

The present invention claims priority to U.S. provisional patent application Ser. No. 60/715,246 filed Sep. 8, 2005 and hereby incorporated by reference.

### BACKGROUND

Users of contemporary computer systems are able to view and generally interact with selected content on a small auxiliary display device coupled to or integrated into a main host computer system. To this end, an auxiliary display screen, along with an operating system-provided auxiliary display device platform, enables developers and authors to present text, graphics and/or video content to users. Example types of content that can be output via an auxiliary display device include email and calendar data, notifications, audiovisual content, internet content and so forth. Auxiliary displays can also show independent data, e.g., related to another purpose such as mobile phone data.

In general, many auxiliary computing concepts are embodied in various types of auxiliary displays, sometimes comprising a small display device embedded in a personal computer form factor, but also embodied in many other devices such as mobile phones, remote control devices, and so forth. Such auxiliary devices generally have their own power source, processor and memory, (or are independently coupled to another power source, processor and memory). This allows a user to view the content on the auxiliary display device even when the main host computer system is in a reduced power state (e.g., ACPI S3 sleep state), or even turned off.

To allow a user to view the content displayed on an auxiliary display device, the user has to be able to read displayed text and/or view displayed graphics or video. Although auxiliary display devices can be incorporated into wall projectors, heads up displays, and/or other devices that can be sensed from a distance (such as speech-to-text converters), few users have such technology, as it is relatively expensive. Moreover, such content is often not private. As a result, a typical user is required to be relatively near an auxiliary display device to use its output in a meaningful way.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards outputting complex state information via an output mechanism, in which the output is configurable to match the state information. The complex state information is conveyable without requiring text, graphics and/or video output capabilities. In one example embodiment, state display logic receives state data from at least one state data source (such as an application program, user or other input and/or a sensor), and applies configuration data (e.g., rules and/or user preferences) to selectively control the output. The output mechanism may comprise a straightforward auxiliary display device, such as at least one LED, and/or luminescent strip, and an existing auxiliary display device platform may be leveraged. Complex state information may be conveyed via differing colors, differing amounts of subcomponents (e.g., LEDs) of the output mechanism to illuminate, differing brightness, differing color intensity, differing hues and/or differing flash patterns (which may include pulsing).

Upon obtaining state data, the configuration data is used in converting the current state data to current complex state information that matches an output mechanism's display capability, e.g., corresponding to an LED set's operating parameters. The output mechanism is driven to display the current complex state information, which is updated when some state change occurs. The output may be viewed from a relatively large distance, and/or viewed remotely on a peripheral device.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment into which various aspects of the present invention may be incorporated.

FIG. 2 is a block diagram generally representing components for presenting state information to a user via one or more auxiliary display devices.

FIG. 3 is a representation of components in one specific example implementation for presenting state information to a user via one or more auxiliary display devices.

FIG. 4 is a representation of various ways to provide auxiliary display devices for viewing by a user.

FIG. 5 is a representation of various ways to provide auxiliary display devices for viewing by a user, including via auxiliary display devices on peripheral devices.

FIG. 6 is a flow diagram representing how to control an auxiliary display device to display current state.

### DETAILED DESCRIPTION

### Exemplary Operating Environment

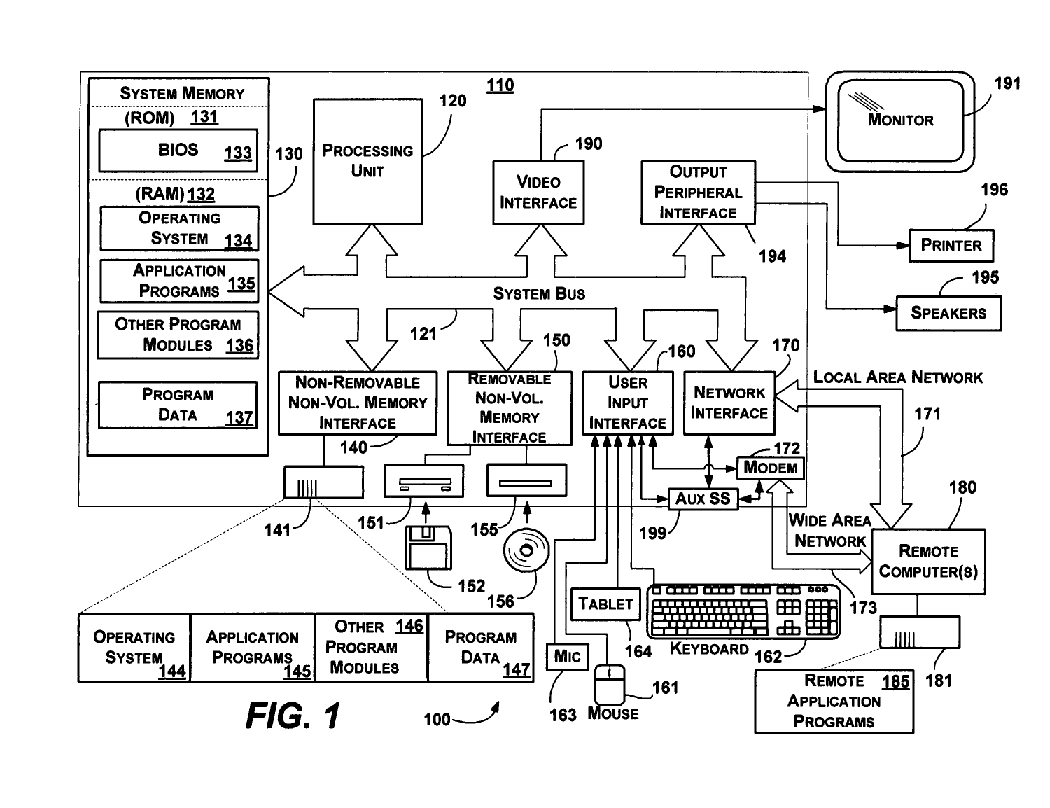

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, described above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It may be appreciated that the network connections shown are exemplary and other means of establishing a communications link between the computers may be used.

An auxiliary subsystem 199 may be connected via the user interface 160 to allow data such as program content, system status and event notifications to be provided to the user, even if the main portions of the computer system are in a low power state. The auxiliary subsystem 199 may be connected to the modem 172 and/or network interface 170 to allow communication between these systems while the main processing unit 120 is in a low power state.

Configurable Output Device for State Information

Various aspects of the technology described herein are directed towards outputting configurable state information via an output mechanism such as an auxiliary display device, where “configurable” refers to programmatic output that may be based on user preference and/or other information. Typically, the example auxiliary display devices described herein are intended to be capable of being sensed (e.g., viewed) from a distance that is far relative to conventional text and graphics screens that may be used as auxiliary devices, e.g., across a room or even in a separate room (via a wireless link as described herein). Although visible from relatively far, the information is private to the extent that only the user that configured the auxiliary display may know the meaning of the output, e.g., light patterns, colors and the like may have meaning only to the user. Notwithstanding, such auxiliary displays may be used in conjunction with devices that output text, graphics, audio/video and other output, and also may be used in conjunction with multiple ambient auxiliary displays; as one example, consider a panel with a set of indicators for each family member (such as a different color for each) that indicated number of emails per person, number of instant messaging contacts online for each person, number of voicemail messages for each person, and so forth.

As a result of generally not requiring close proximity interaction, in some scenarios example output mechanisms may be referred to as “ambient” auxiliary displays/devices, although as will be understood, certain embodiments require a line-of-sight for use in viewing. Further, despite the name “display” device shown in the examples used herein, output mechanisms are not limited to viewable displays, but rather refers to any type of mechanism that outputs state information that is capable of being sensed by a user, including visual, smell, audible and/or tactile output.

As exemplified herein, an auxiliary display device may comprise a simple, relatively inexpensive output mechanism such as a set of LEDs, a luminescent strip, a light, and so forth. In general, auxiliary displays are capable of outputting complex state information, where “complex” refers to more than a binary on or off state, (e.g., multi-state data, such as a range, a number and/or a frequency), although such devices can be configured to show binary state.

Still further, while an auxiliary display device may be of the type that is coupled to a host computer system by being physically built into the housing, e.g., in a laptop, other types of auxiliary devices and actuators may similarly leverage the technology described herein, including devices not conventionally thought of as being “computer-system” peripherals. Such devices include television sets, audio receivers, audio/video recorders, telephones, a separate computer, a mobile communications device, a secondary display screen with actuators, a watch, a wall (e.g., kitchen) display, a display screen, a digital picture frame, a clock, a radio, a media player, a device embedded within or using the main display of a consumer electronics device, automotive, transportation or other vehicular units, keyboards or other input devices of the main computer system, a pager, a personal digital assistant, and so forth. As such, the present invention is not limited to the examples, structures or functionality described herein; rather, any of the examples, structures or functionality described herein are non-limiting, and the present invention may be used various ways that provide benefits and advantages in computing and device usage in general.

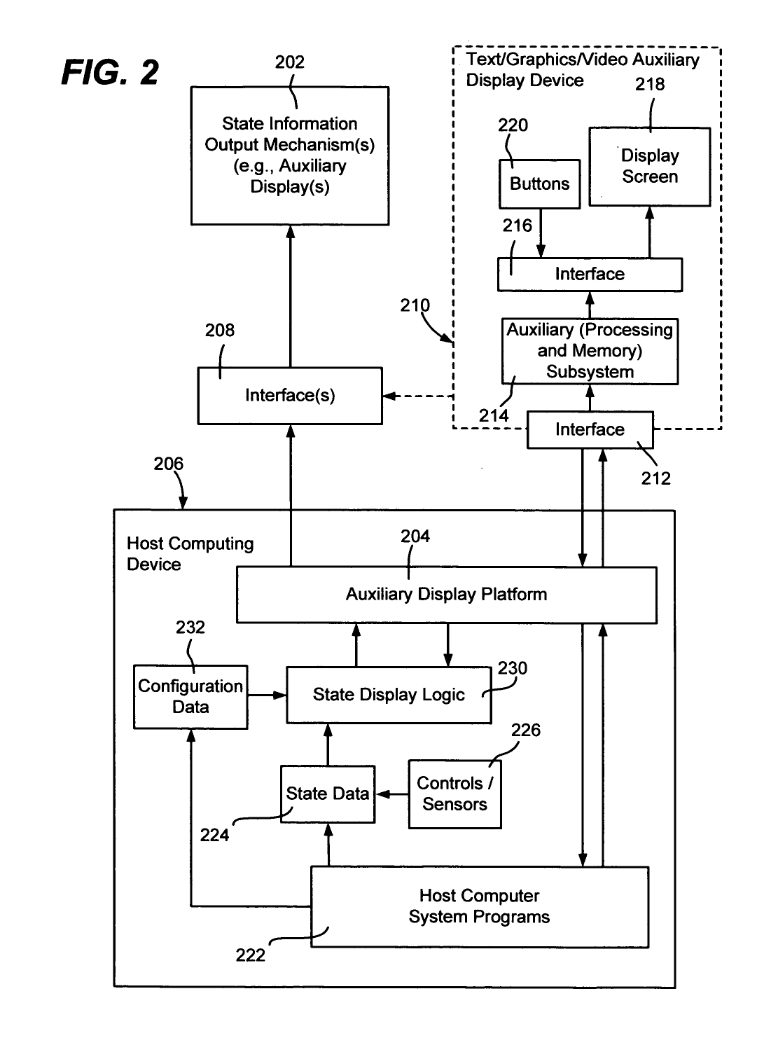

Turning to FIG. 2 of the drawings, there is shown an example architecture for operating one or more state information output mechanism(s) 202, e.g., configured as auxiliary display(s). In general, an auxiliary display platform 204 of a host computing device 206 (such as based upon the computer system 110 of FIG. 1) outputs state information to the output mechanism(s) 202 via a suitable interface set 208. The auxiliary display platform 204 optionally (as indicated by the dashed box) may be coupled to a text, graphics and/or video auxiliary display device 210 through an interface 212. The example device 210 represented in FIG. 2 includes an auxiliary subsystem 214 (e.g., including a processor and memory) coupled through at least one interface 216 to a display screen 218 and buttons 220 (and/or other input means such as a touch panel or a remote control). Note that there need not be input means, e.g., a display may automatically cycle through information.

In the example shown in FIG. 2, the host computing device 206 includes programs 222 (e.g., application programs, operating system components, control programs and so forth), at least some of which are capable of outputting information that reaches the auxiliary display platform 204 in some form. Note that some of the programs 222 may be auxiliary device-aware, and thus capable of sending information to the auxiliary platform 204 and receiving information (e.g., events) from the auxiliary platform 204. This may include information used to control the auxiliary display(s) 202, such as by converting the information (e.g., number of unread email messages) via state display logic 230 into output (e.g., which particular ones of a plurality of LEDs, which colors and/or which flash patterns to drive). However, state data 224 may be obtained from programs in other ways, such as by calling the program and querying for state data, and/or by intercepting input and output from the programs 222, such as messages, events and/or notifications. Note that although the state display logic 230 is shown as being external to the auxiliary display platform 204, it is feasible to incorporate at least some of the state display logic into the auxiliary display platform 204.

Thus, the state data 224 may come directly or indirectly from the programs 222, but may also come from controls (such as user buttons) and/or sensors 226 and the like. For example, a low power state or thermal state may override the state information that would otherwise be displayed, such as by flashing an output mechanism 202 in a certain pattern, or turning if off altogether. A user button press may instruct the state display logic 230 that a different set of state information should be conveyed from what is currently being displayed, or the output mechanism 202 itself may be activated or deactivated by user input, and/or activated/deactivated by user presence/absence, which may be automatically detected.

This state data 224, along with any state data taken from information sent by the programs 222 or the auxiliary device 210 to the auxiliary display platform 204, may be used to control the output mechanism(s) 202. To this end, the state display logic 230 determines how to operate the output mechanism(s) 202 to convey state information, based on configuration data 232, (e.g., data possibly based on user preferences that may override predefined default rules or the like). Various ways to convey information visually include color(s), flash pattern(s), intensity, and/or number and orientation of subcomponents of the auxiliary display to illuminate, (e.g., the number of LEDs that are powered, and/or an arrangement, such as vertical, horizontal and/or diagonal); these ways to convey the information may be interleaved occasionally (e.g., periodically or in some other way), so that different sets of complex state information may be shown on an alternating basis. It is to be appreciated that other sensory output mechanisms may incorporate similar or different types of patterns, such as vibration pattern, intensity, auditory tone, pattern, pitch, and so forth.

By way of a simple example, consider an output mechanism in the form of an auxiliary display comprising a set of one or more LEDs. The user can configure user preferences such that the LED set shows a current state of traffic conditions for a certain area based on their current color, e.g., green for light, yellow for medium and red for heavy. Note that the user can configure the preferences such that the same LED set may convey other state information at non-commuting times, e.g., to show approximately how many email messages are currently unread. For example, the display may indicate a general number of unread email messages, e.g., through a bank of LEDs, in which more LEDs light up when there are more unread messages; the user may be allowed to configure how many unread messages each LED represents (which need not be linear). The number of LEDs illuminated may be combined with other information, such as to display the urgency of messages or sender by brightness, or, if color-changeable LEDs are used, by increasing the color intensity and hue as the number of unread emails increases (or if urgent and so forth), and/or by the use of flash patterns.

Thus, as can be understood, output mechanisms can output state information for both non-computer-related state (e.g., traffic) and computer-related state (e.g., unread email messages). Other examples of applications that enable users to obtain state information at a glance include system security (e.g., whether the user's computer is secure, such as adequately protected against viruses and/or other threats), battery charge level, the action a media playback and recording device is currently performing, general or specific computer health state, weather conditions (current and/or forecast), current stock prices, and so on.

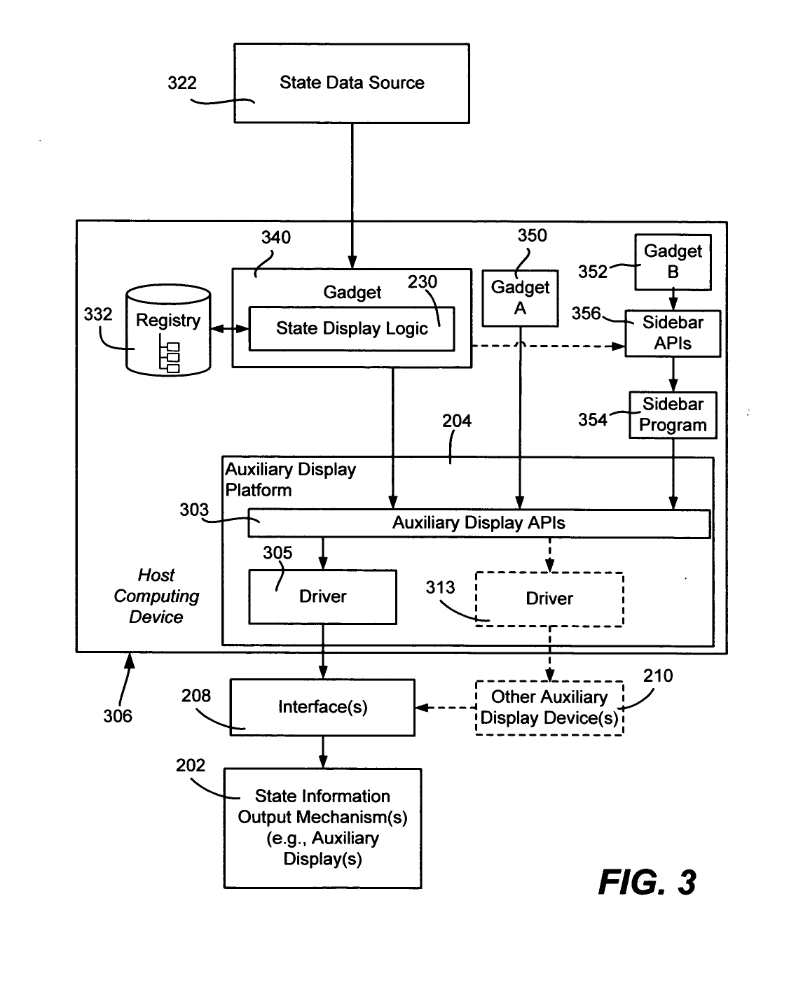

FIG. 3 shows a more specific example configuration in which the state display logic 230 is incorporated into a gadget 340, wherein in general, a gadget comprises small plug-in type computer program that runs on a host device 306, and which obtains and processes content from another data source 322 (such as originating from the application programs 222 of FIG. 2) or sources, e.g., sensors and controls. Examples of gadgets include programs that can connect to web services to deliver weather information, news updates, traffic maps, Internet radio streams, and slide shows of online photo albums. Gadgets can also integrate with existing application programs to streamline a user's interaction with them. Gadgets can also have any number of dedicated purposes, e.g., to access calculators, games, sticky notes, and so forth.

For completeness, FIG. 3 shows other gadgets that may be used with the auxiliary display platform, including “Gadget A” 350, and “Gadget B” 352. Note that Gadget B 352 works with a sidebar program 354 via sidebar APIs 356 to communicate with the auxiliary display APIs 303; the sidebar APIs 356 are generally configured to call the auxiliary display APIs 303 in response to handling its own API calls. The gadget 340 that hosts the state display logic 230 may alternatively operate via the sidebar APIs 356 (as indicated by the dashed arrow from block 340 to block 356).

In the example of FIG. 3, the user preference data or the like may be read from a registry 332, (although preference data may be maintained anywhere, including downloading from a remote location), and the auxiliary display platform 204 of FIG. 2 includes auxiliary display APIs 303 and one or more drivers 305 (and 313).

Note that in FIGS. 2 and 3, the host computing device (206, 306 respectively) is shown as being operational to control the auxiliary display(s) 202. As can be readily appreciated, however, the auxiliary display device 210, if present, can be configured to control the auxiliary display(s) 202, such as when the host computing device 206 is off or in a sleep state. In FIGS. 2 and 3, this is indicated by the dashed line between the auxiliary display device 210 and the interface(s) 208, although a different interface may be used.

Because of the auxiliary display platform 204, the auxiliary display(s) 202 can be configured to output a variety of state information, including by a device manufacturer, by a program developer and/or by a user. The auxiliary display(s) 202 may reflect the state of any data that comes from an appropriate data provider. Auxiliary displays are thus far more flexible than conventional status indicators known in contemporary computer systems, e.g., because the state information is determined from a data provider resident or in communication with the device, rather than indicating a status of the device itself.

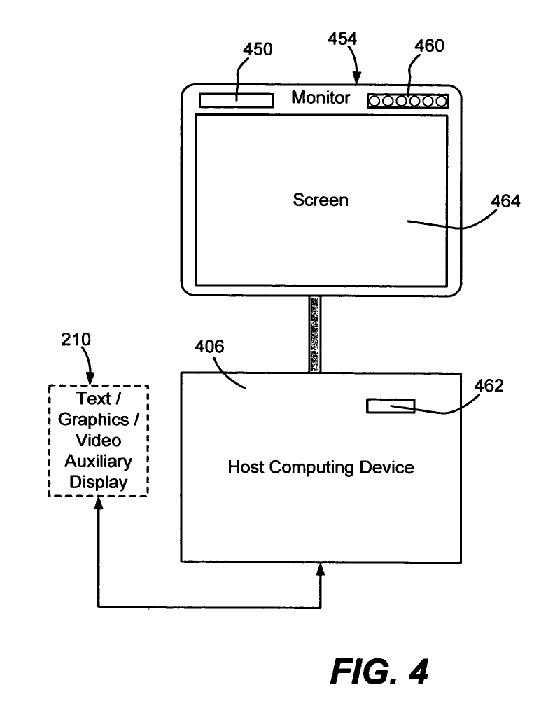

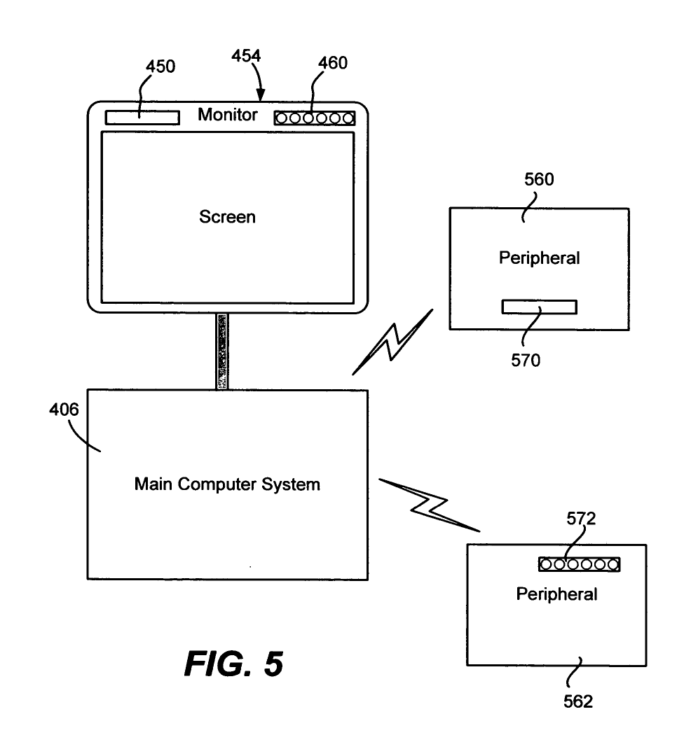

FIGS. 4 and 5 show various alternative ways in which an auxiliary display may be implemented. Note that although various mechanisms are shown in FIGS. 4 and 5, there may be as little as one such mechanism in a given user scenario, or more than those shown, up to any practical number.

In FIG. 4, a luminescent strip 450 is shown built into (or retrofitted/mounted) to a monitor 454 to act as an auxiliary display. As but one example, the system may be configured such that the luminescent strip 450 shows the current state of media playback, such as to display one color/pattern (e.g., pulsing red) when the device is recording something, another color/pattern (e.g., glowing blue) when the device is playing back media, and another color/pattern (e.g., blinking yellow) when a notification is available and/or displayed elsewhere.

Instead of or in addition to the luminescent strip 450, a set of one or more LEDs 460 may be mounted to or incorporated into the monitor 454 to act as an auxiliary display. As is understood, unlike a conventional monitor LED that shows power on/off states and/or possibly other information related to the monitor, the LED set 460 is configurable to convey state information obtained from a program, (possibly modified by user preferences and/or other state information obtained via controls or sensors as described above).

Moreover, as can be readily appreciated, auxiliary displays are not limited to devices positioned on or proximate a monitor. For example, an output mechanism 462 (e.g., LED set or luminescent strip) may be incorporated into or mounted onto the housing of the host computing device 406. Still further, the main display screen 464 itself can at times work as an auxiliary display to convey state, e.g., the screen may be configured to show (or occasionally show) a certain color or the like that indicates a certain program state when otherwise the screen 464 would be in a screen saver mode or turned off.

Whereas FIG. 4 illustrates an example of an auxiliary display device proximate the host device, FIG. 5 exemplifies another output mechanism concept, namely attaching ambient auxiliary displays to peripheral devices 560 and 562. Peripheral devices may include any peripheral device, including wireless devices (as shown) as well as to any wired devices, such as a mouse or stylus, phone, keyboard, printer, microphone, remote control, or any other device in communication with the host computing device. As represented in FIG. 5, a system that has attached peripherals may have auxiliary displays built into or coupled to these peripherals 560 and 562, so that state data can be displayed across the different peripherals. Typical output mechanisms for peripheral devices include a luminescent strip 570 and LED set 572, although other types of output mechanisms such as perimeter lighting, backlighting and so forth are feasible.

One example of a peripheral device that may include an auxiliary display includes a media center remote control, e.g., for a personal computer that is configured for media playback and record functionality. For example, such a remote control can operate a media center personal computer, while also letting the user know something about the state of the host personal computer or other state information, e.g., by having some number of unread email messages correspond to a particular color that the device glows (or selectively glows when a button thereon is pressed, the device is touched, or via some other activation mechanism).

Another example peripheral device comprises a media extender (e.g., a device that typically operates like a television set-top box). As is understood, with a media center setup, the user may receive state data via the computer system itself, via the monitor, via the media extender (e.g., in another room) and/or via the remote control from which the personal computer is otherwise receiving signals. Such peripheral displays enable any part of a computer system to display information through a similar auxiliary display. Essentially any device that may be coupled to a computer system is feasible for auxiliary display of information, including devices coupled by network connections, even those coupled via the Internet or via any other communication means, such as BlueTooth® or the like.

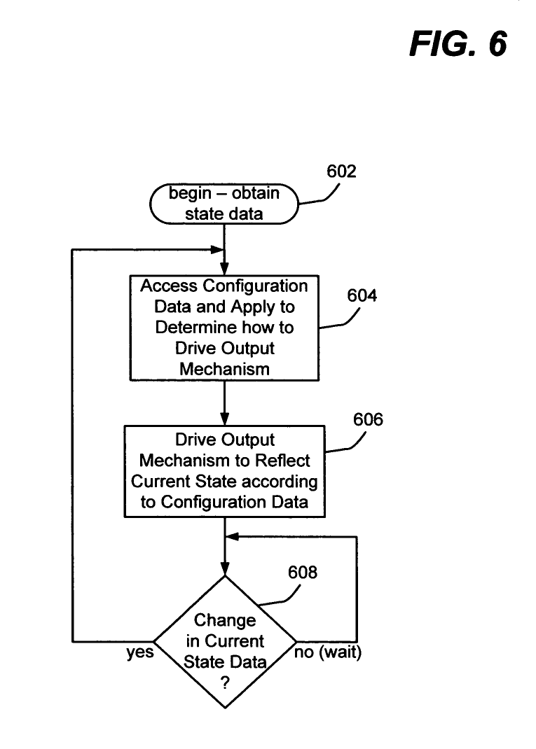

FIG. 6 summarizes various concepts described above via example steps of a flow diagram. In general with reference to FIGS. 2 and 6, the state display logic 230 obtains state data at step 602, and at step 604 accesses the configuration data 232 (e.g., rules and/or user preferences) to determine how an auxiliary display (a type of output mechanism) 202 should be driven. For example, configuration data 232 may associate particular application state data with a desired auxiliary display performance. Note that the state display logic 230 may use different sets of configuration data 232 for different auxiliary displays and/or types, e.g., a luminescent strip may have one set of rules and/or user preferences, a bank of LEDs another set of rules and/or user preferences, and there may be different sets of configuration data for different auxiliary displays, such as one set for a luminescent strip on a monitor and another set for a luminescent strip on a peripheral device. Still further, configuration data 232 may be reactive to a particular status of a host or peripheral device (e.g., whether the user is currently on the phone, or in a meeting. The configuration data 232 also may specify rules to affect output according to virtually any current criteria, e.g., time of day, user presence, day of week, current user, network connectivity state, and so forth.

Step 606 represents driving the output mechanism (e.g., via its interface 208) to reflect the state, in the manner determined at step 604. Step 608 represents looping back upon a change in state data, which may be event driven, periodically or otherwise queried for, and so forth. Note that as used herein, a state change may occur via a program, via a sensor or control that detects user interaction, via timing or some other event, and so forth. Thus, the yes branch of step 608 essentially represents any time the output mechanism is re-driven, which may not actually be a change but a refresh or the like in case the output mechanism has changed in some way; moreover the change may be planned by the system rather than by a program, control or sensor, such as to periodically alternate what is being shown via the output mechanism between two or more sets of state information.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising:
an output mechanism that is configured to output complex state information without requiring text, graphics and/or video output capabilities; and
state display logic that receives state data from at least one state data source, the state display logic determining the complex state data to correspond to the received stated data, the state display logic coupled to the output mechanism to control the output mechanism to output the complex state information, in which the state display logic is configurable to selectively control the complex state information based on configuration data.

2. The system of claim 1 wherein the output mechanism comprises a set of at least one LED.

3. The system of claim 1 wherein the output mechanism comprises a luminescent strip.

4. The system of claim 1 wherein the state data source comprises an application program.

5. The system of claim 4 wherein the application program is coupled to the state display logic via at least one component of an auxiliary display platform.

6. The system of claim 1 wherein at least part of the state display logic is incorporated in a gadget program.

7. The system of claim 1 wherein the configuration data includes user definable preference data.

8. The system of claim 1 wherein the state data source includes a sensor and/or a control.

8. The system of claim 1 wherein the state data source includes a sensor or a control or both a sensor and a control.

9. The system of claim 1 wherein the complex state information includes one or more of a group comprising: differing colors, differing numbers of subcomponents of the output mechanism to illuminate, differing orientations, differing brightness, differing color intensity, differing flash frequencies, and differing flash patterns.

11. The system of claim 1 wherein the output mechanism is remotely coupled to a computing device on which the state display logic is executing.

12. In a computing environment, a method comprising:
(a) obtaining state data from at least one source and setting the state data as current state data;
(b) applying configuration data to convert the current state data to current complex state information that matches an output mechanism's display capability, the complex state information being different from the current state data;
(c) driving the output mechanism to display the current complex state information; and
(d) when a state change occurs, returning to step (a).

13. The method of claim 12 wherein the output mechanism comprises a plurality of LEDs, and wherein applying the configuration data to convert the current state data to current complex state information that matches an output mechanism's display capability comprises determining how many of the LEDs to illuminate.

14. The method of claim 13 wherein the output mechanism comprises a luminescent strip or an LED, and wherein applying the configuration data to convert the current state data to current complex state information that matches an output mechanism's display capability comprises selecting one member of a group comprising: a color for driving the output mechanism; a brightness for driving the output mechanism; an intensity for driving the output mechanism; a flash pattern for driving the output mechanism; an orientation for driving subcomponents of the output mechanism; or a pulsing pattern for driving the output mechanism.

15. The method of claim 13 wherein obtaining the state data comprise communicating to obtain the state data from an application program.

16. The method of claim 13 wherein applying the configuration data comprises accessing user definable preference data.

17. A computer-readable medium having computer-executable instructions, which when executed perform steps, comprising:
detecting complex state data including state data related to an application program state running on a host computer system; and
applying configuration data to determine how to control an auxiliary device to convey information that corresponds to the complex state data.

18. The computer-readable medium of claim 17 wherein the auxiliary device is detachable from the host computer system, and further comprising, outputting signals to a receiving device coupled to the auxiliary device to control the auxiliary device to convey the information.

19. The computer readable medium of claim 17 wherein the information includes visually perceived information.

20. The computer-readable medium of claim 17 wherein the step of applying configuration data occurs when the host computer system is in an inactive state.
